(19) United States
(12) Patent Application Publication
(10) Pub. No.: US 2023/0172812 A1
(43) Pub. Date: Jun. 8, 2023

(54) TEETHING HARNESS

(71) Applicant: Pamela Hope Roth, Washinqton, DC (US)

(72) Inventor: Pamela Hope Roth, Washinqton, DC (US)

(21) Appl. No.: 17/545,459

(22) Filed: Dec. 8, 2021

(51) Int. Cl. A61J 17/00; A61J 17/02

(52) U.S. Cl. CPC A61J 17/1115; A61J 17/02; A61J 17/1111

(57) ABSTRACT

A material/flexible harness that has three (3) teething toys built in and is secured to a child's body over clothing by straps with hooks and loop fasteners.

### CROSS-REFERENCE TO RELATED APPLICATIONS

Not Applicable

### STATEMENT REGARDING FEDERALLY SPONSORED RESEARCH OR DEVELOPMENT

### Not Applicable

### REFERENCE TO SEQUENCE LISTING, A TABLE, OR COMPUTER PROGRAM

Not Applicable

### BACKGROUND OF THE INVENTION

Baby toys, baby teething items. The Teething Harness solves the problem of children dropping their chew toys or their chew toys falling out of their mouth and dropping to the ground or floor.

### BRIEF SUMMARY OF THE INVENTION

The Teething Harness is a soft material/flexible rubber harness that wraps around the child's neck and torso and has three built-in baby teething/play items—a chew ring, a flat flexible chew stick, and a length of flat flexible material that can be used to secure a pacifier. The harness can be used over or in place of a bib and allows a child to utilize up to 3 chew items without risk of the items falling to the ground or floor.

### BRIEF DESCRIPTION OF THE VIEW OF THE DRAWING

FIG. 1 depicts the front view of the harness.

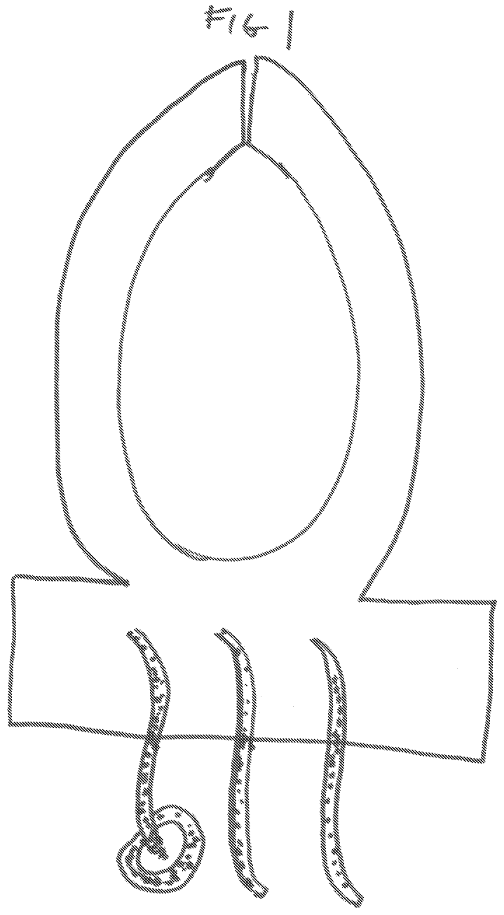

FIG. 2 is an overhead view of the harness.

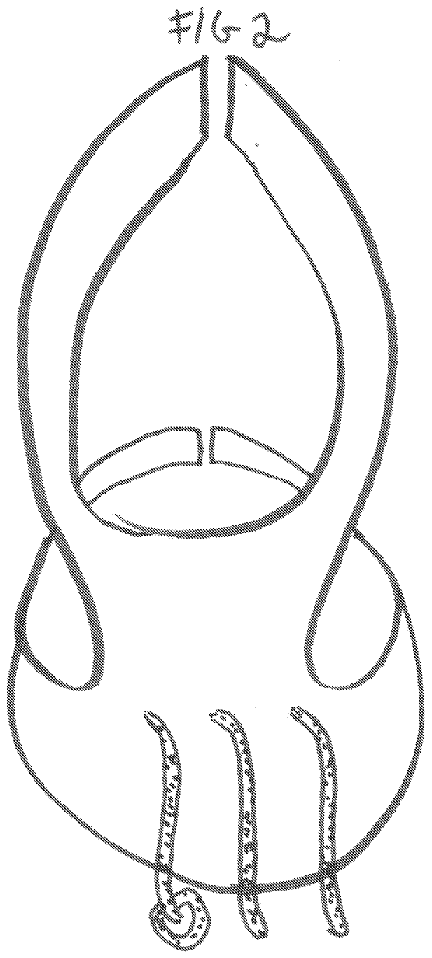

### DETAILED DESCRIPTION OF THE INVENTION

The Teething Harness is a soft material harness that wraps around the child's neck and torso and has three built-in baby teething/play items—a chew ring, a flat flexible chew stick, and a length of flat flexible material that can be used to secure a pacifier. The harness can be used over or in place of a bib and allows a child to utilize up to 3 chew items without risk of the items falling to the ground or floor. The material is soft flexible cloth/plastic/rubber free of BPA, phthalates, and PVC. The harness secures around the neck and torso by the use of 1-2 inches length of a hook and loop fastener that is attached to each end of the neck piece and to each end of the torso piece. The Teething Harness is made of one piece of material and the 6 inch lengths of material from which the baby teething items descend including the chew ring itself are attached to that single piece of material. The pacifier that may be attached to the third length of material is not part of the harness and would be added by the buyer. While the bib part of the harness is smooth, both the teething ring (toy 1) and the teething strip (toy 2) are covered in small bumps to act as a teething mechanism. The third length of material to which a pacifier can be attached also has small bumps on it and has about 1-2 inches of a hook and loop fastener at its end to allow for a pacifier to be secured. The main body of the harness measures about 4 inches in length at its widest point and between 16 and 20 inches wide including the lengths where the harness secures around the torso of the child.

1. The Teething Harness allows for the access to and use of multiple teething toys by a child indoors or outside, while eliminating the risk of the toys falling to the ground or floor and precluding the teething toys from becoming dirty and unusable or lost.
